(19) United States
(12) Patent Application Publication
(10) Pub. No.: US 2012/0136685 A1
(43) Pub. Date: May 31, 2012

(54) Determining Thresholds of Unexpected Workload Volumes

(75) Inventors: David M. Northcutt, Chester, NJ (US); George E. Stark, Austin, TX (US); James A. Tyler, Westminster, CO (US)

(73) Assignee: INTERNATIONAL BUSINESS MACHINES CORPORATION, Armonk, NY (US)

(21) Appl. No.: 12/957,093

(22) Filed: Nov. 30, 2010

(51) Int. Cl. G06Q 10/00

(52) U.S. Cl. 705/7.14

(57) ABSTRACT

A computer implemented method allocates resources within a workload management program. A computer identifies a first ratio for a first skill team of plurality of skill teams. The computer determines whether the first ratio for the first skill team exceeds a skill team threshold of the first skill team. Responsive to the computer determining that the first ratio for the first skill team exceeds the skill team threshold of the first skill team, the computer allocates the resources from at least one of the plurality of skill teams other than the first skill team to the first skill team. A computer program product and a computer system for allocating resources within a workload management program are also provided.

### BACKGROUND

1. Field

The disclosure relates generally to workload management programs. More specifically, the disclosure relates to determining thresholds of unexpected workload volumes in workload management programs.

2. Description of the Related Art

Workload management programs are used to assign incoming work to available resources to ensure the work is completed on time and with a successful outcome. The IBM® Global Delivery Framework™ uses a method of segmenting work by complexity, for example, simple, medium, and complex, to improve efficiency in handling normal workload by assigning the work to a subset of a team with proper skills and available resources. The Global Delivery Framework uses a set of rules to determine when to request resources from other subsets of the team to help handle an unexpected increase in volume. This method helps bring resources to bear to address the volume.

### SUMMARY

According to one embodiment of the present invention, a computer implemented method for allocating resources within a workload management program. A computer identifies a first ratio for a first skill team of a plurality of skill teams. The computer determines whether the first ratio for the first skill team exceeds a skill team threshold of the first skill team. Responsive to the computer determining that the first ratio for the first skill team exceeds the skill team threshold of the first skill team, the computer allocates the resources from at least one of the plurality of skill teams other than the first skill team to the first skill team.

According to another embodiment of the present invention, a computer program product for allocating resources within a workload management program. The computer program product comprises one or more computer-readable, tangible storage devices. Program instructions, stored on at least one of the one or more storage devices, identify a first ratio for a first skill team of a plurality of skill teams. Program instructions, stored on at least one of the one or more storage devices, determine whether the first ratio for the first skill team exceeds a skill team threshold of the first skill team. Program instructions, stored on at least one of the one or more storage devices, responsive to determining that the first ratio for the first skill team exceeds the skill team threshold of the first skill team, allocate the resources from at least one of the plurality of skill teams other than the first skill team to the first skill team.

According to another embodiment of the present invention, a computer system for allocating resources within a workload management program. The computer system comprises one or more processors, one or more computer-readable memories and one or more computer-readable, tangible storage devices. Program instructions, stored on at least one of the one or more storage devices for execution by at least one of the one or more processors via at least one of the one or more memories, identify a first ratio for a first skill team of a plurality of skill teams. Program instructions, stored on at least one of the one or more storage devices for execution by at least one of the one or more processors via at least one of the one or more memories, determine whether the first ratio for the first skill team exceeds a skill team threshold of the first skill team. Program instructions, stored on at least one of the one or more storage devices for execution by at least one of the one or more processors via at least one of the one or more memories, responsive to determining that the first ratio for the first skill team exceeds the skill team threshold of the first skill team, allocate the resources from at least one of the plurality of skill teams other than the first skill team to the first skill team.

### BRIEF DESCRIPTION OF THE SEVERAL VIEWS OF THE DRAWINGS

FIG. 1 is an illustrative diagram of a network of data processing systems in which illustrative embodiments may be implemented;

FIG. 2 is an illustration of a data processing system in accordance with an illustrative embodiment;

FIG. 3 is a workload management program according to an illustrative embodiment;

FIG. 4 is a process behavior control chart according to an illustrative embodiment; and

FIG. 5 is a flowchart for reallocating resources within a workload management program according to an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

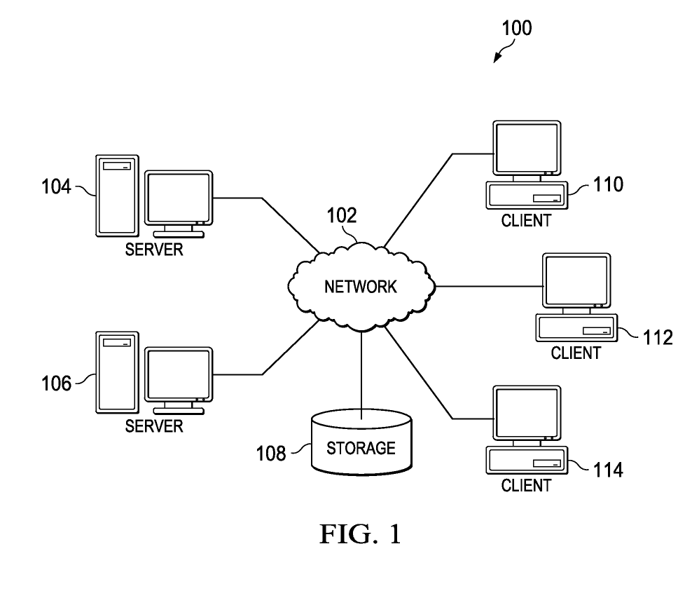

With reference now to the figures and in particular with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers and other devices in which the illustrative embodiments may be implemented. Network data processing system 100 contains network 102, which is the medium used to provide communications links between the computers and the other various devices connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 and/or server computer 106 in this example. Network data processing system 100 may include additional server computers, client computers, and other devices not shown.

Program code located in network data processing system 100 may be stored on a computer readable storage medium and downloaded to a data processing system or other device for use. For example, program code may be stored on a computer readable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

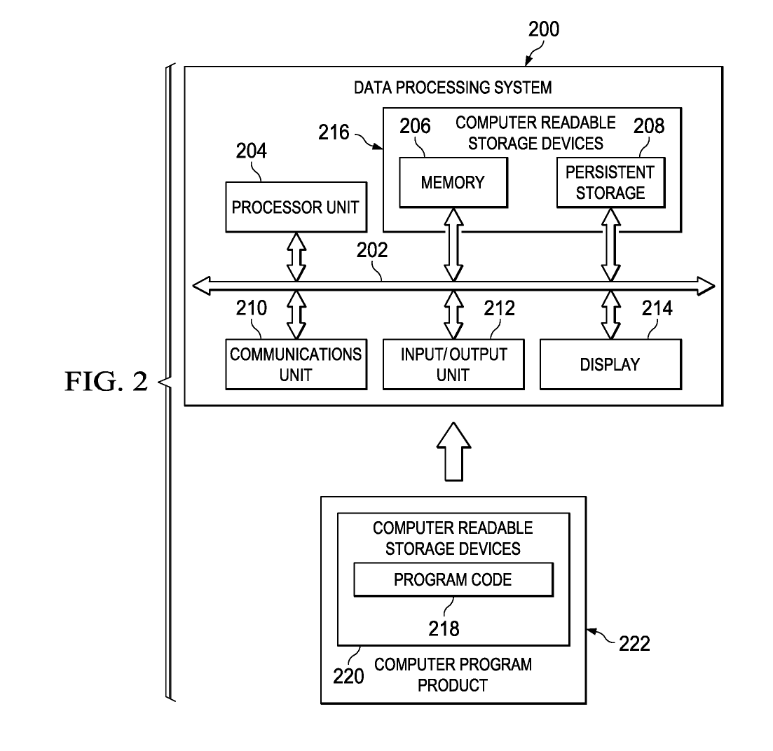

Turning now to FIG. 2, an illustration of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of computer readable storage devices 216. Memory 206, in these examples, may be, for example, a random access memory or any other suitable volatile or non-volatile computer readable storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for an operating system, applications, and/or programs may be located in computer readable storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, program instructions, or computer readable program instructions that may be read and executed by processor unit 204. The program code in the different embodiments may be embodied on different physical or computer readable storage devices, such as memory 206 or persistent storage 208.

Program code 218 is located in a functional form on one or more of computer readable storage devices 220. One or more of computer readable storage devices 220 can be selectively removable from data processing system 200. Program code 218 may be loaded onto or transferred to data processing system 200 for running by processor unit 204. Program code 218 and computer readable storage devices 220 form computer program product 222.

In some illustrative embodiments, program code 218 may be downloaded over a network to persistent storage 208 from another device or data processing system via communications unit 210 for use within data processing system 200. For instance, program code stored in a computer readable storage device in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being.

For example, processor unit 204 may take the form of a hardware unit that has circuits that are manufactured or configured for a particular use. This type of hardware may perform operations without needing program code to be loaded into a memory from a computer readable storage device to be configured to perform the operations.

For example, when processor unit 204 takes the form of a hardware unit, processor unit 204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 218 may be omitted because the processes for the different embodiments are implemented in a hardware unit.

In still another illustrative example, processor unit 204 may be implemented using a combination of processors found in computers and hardware units. Processor unit 204 may have a number of hardware units and a number of processors that are configured to run program code 218. With this depicted example, some of the processors may be implemented in the number of hardware units, while other processors may be implemented in the number of processors.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206, or a cache, such as found in an interface and memory controller hub that may be present in communications fabric 202.

In the course of developing the invention, it was determined that in most cases, an unexpected and temporary increase of volume of workload can be handled by available resources working overtime to handle the volume or by bringing in other temporary resources from other organizations or from additional hiring to address the temporary volume surge. However, both of the above solutions are not without disadvantages. Overtime workload may cause additional errors due to over-worked resources. Furthermore, overtime workload may result in loss of resources by attrition of those who are unwilling to work the overtime required. Bringing in additional resources takes time and may incur additional cost in training. Additional resources may also result in an over-staffing situation when the unexpected volume has been addressed.

In addition, there is no easy way to determine what constitutes an unexpected increase of workload volume. While the methodology of the Global Delivery Framework helps to allocate resources to address the volume, it remains difficult to determine what constitutes an unexpected increase in workload volume when the number of available resources may be different at any given time.

Illustrative embodiments herein provide a computer implemented method for determining thresholds of unexpected workload volumes in a workload management program. A first ratio for a first skill team of a plurality of skill teams is identified. If the first ratio for the first skill team exceeds a skill team threshold of the first skill team, resources are allocated from at least one of the plurality of skill teams other than the first skill team to the first skill team.

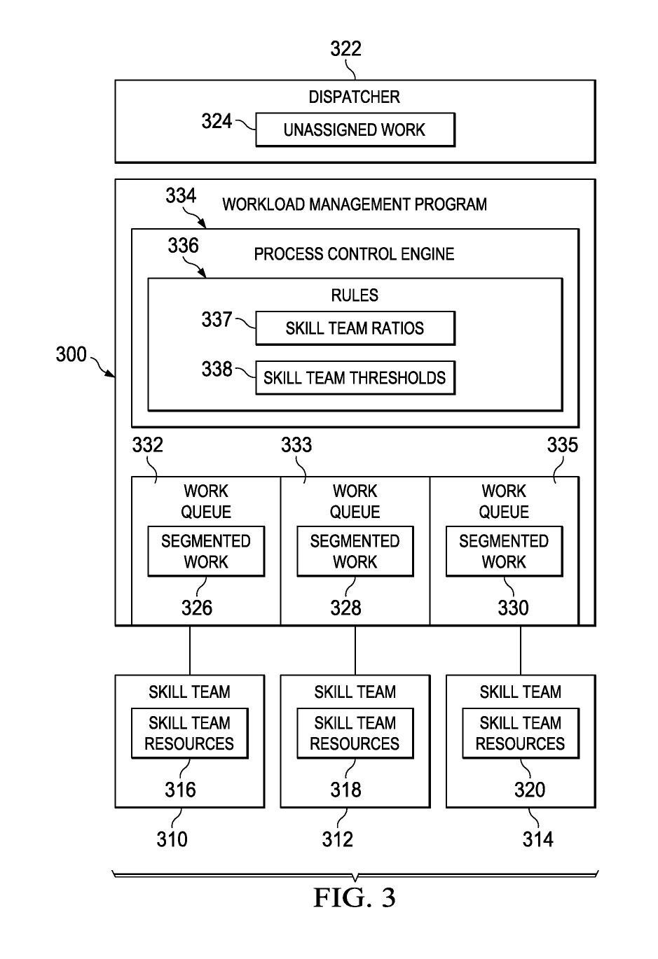

Referring now to FIG. 3, a workload management program is shown according to an illustrative embodiment. Workload management program 300 is a software program that can comprise program code, such as program code 218 of FIG. 2, and can execute on a data processing system, such as data processing system 200 of FIG. 2.

Workload management program 300 manages workloads for a set of skill teams. The set of skill teams includes one or more skill teams, such as skill teams 310, 312, and 314. Workload management program 300 manages work for skill teams 310, 312, and 314 that they are capable of completing. In one illustrative embodiment, each of skill teams 310, 312, and 314 is a group of employees having a particular level of expertise in a given area. Dispatcher 322 utilizes workload management program 300 to assign work to each of skill teams 310, 312, and 314 based on the complexity of the work, the expertise of skill teams 310, 312, and 314, and the availability of skill team resources 316, 318, and 320.

Skill teams 310, 312, and 314 include skill team resources 316, 318, and 320, respectively. Skill team resources 316, 318, and 320 are the resources that are available to perform the work that workload management program 300 has assigned to a respective one of skill teams 310, 312, and 314. In one illustrative embodiment, each of skill team resources 316, 318, and 320 is the employees that are assigned to the respective one of skill teams 310, 312, and 314.

Workload management program 300 initially stores incoming work in unassigned work 324. Unassigned work 324 is a data structure containing work that dispatcher 322 has not assigned to a particular one of skill teams 310, 312, and 314.

Dispatcher 322 examines work stored in unassigned work 324. Based on the complexity of the work stored in unassigned work 324, the expertise of the associated one of skill teams 310, 312, and 314, and the availability of skill team resources 316, 318, and 320, dispatcher 322 sorts the work into one or more of segmented work 326, 328, and 330. Each of segmented work 326, 328, and 330 is work that has been assigned to a particular one of skill teams 310, 312, and 314 through sorting by dispatcher 322. Dispatcher 322 then stores segmented work 326, 328, and 330 into an associated one of work queues 332, 333, and 335.

Each of work queues 332, 333, and 335 is a data structure containing sorted work that has been assigned to an associated one of skill teams 310, 312, and 314 based on the complexity of the assigned work, the expertise of the associated one of skill teams 310, 312, and 314, and the availability of skill team resources 316, 318, and 320. Segmented work 326 within work queue 332 contains work that is assigned to skill team 310. Segmented work 328 within work queue 333 contains work that is assigned to skill team 312. Segmented work 330 within work queue 335 contains work that is assigned to skill team 314. Skill team resources 316 performs segmented work 326 from work queue 332 that has been assigned to skill team 310. Skill team resources 318 performs segmented work 328 from work queue 333 that has been assigned to skill team 312. Skill team resources 320 performs segmented work 330 from work queue 335 that has been assigned to skill team 314.

Typically, variations exist in the type of work that is incoming, such that there may be a higher or lower volume of work of a particular skill level. Different ones of skill teams 310, 312, and 314 may have differing amounts of backlog within work queues 332, 333, and 335, respectively that has not yet been performed by a particular member of skill team resources 316, 318, and 320.

When the volume of segmented work 326, 328 or 330 exceeds an associated one of skill team thresholds 338, it may be beneficial to utilize skill team resources, such as skill team resources 316, 318, and 320, to assist in performing work that is outside the particular level of expertise of the associated one of skill teams 310, 312, and 314. For example, if one of skill team resources 318 possesses the necessary expertise to perform work normally allocated to skill team 310, dispatcher 322 can utilize workload management program 300 to assign skill team resources 318 to perform segmented work 326 from work queue 332 when the volume of segmented work 328 exceeds an associated one of skill team thresholds 338. Similarly, if one of skill team resources 320 possess the necessary expertise to perform work that would otherwise be allocated to skill team 312, dispatcher 322 can utilize workload management program 300 to assign skill team resources 320 to perform segmented work 328 from work queue 333 when the volume of segmented work 330 exceeds an associated one of skill team thresholds 338.

Process control engine 334 is configurable program logic that tracks the historical workload for skill teams 310, 312, and 314 and determines when resources from one of skill teams 310, 312, and 314 can be utilized to complete tasks normally allocated to another of skill teams 310, 312, and 314. Process control engine 334 determines when the volume of work for a particular one of skill teams 310, 312, and 314 is large enough such that resources from others of skill teams 310, 312, and 314 should be requested to help process the backlog of assigned work. Similarly, process control engine 334 determines when the volume of work for a particular one of skill teams 310, 312, and 314 is small enough such that resources from that particular skill team can be released to help others of skill teams 310, 312, and 314 process the backlog of assigned work.

Process control engine 334 utilizes rules 336 to determine when to reallocate resources between one or more of skill teams 310, 312, and 314. Rules 336 are configurable rules. Process control engine 334 applies rules 336 to determine periods when segmented work 326, 328, or 330 exceeds an associated one of skill team thresholds 338, and to then reallocate resources between one or more of skill teams 310, 312, and 314. In one illustrative embodiment, process control engine 334 utilizes rules 336 to determine when to reallocate resources between one or more of skill teams 310, 312, and 314 based on a historical statistical process control analysis of one or more of skill team ratios 337.

Process control engine 334 calculates and maintains skill team ratios 337 for each of skill teams 310, 312, and 314. Each of skill team ratios 337 is a ratio of work within one of work queues 332, 333, and 335 to the present number of resources available to perform the assigned work, that is, the number of members of a particular skill team resource, such as one of skill team resources 316, 318, and 320. Process control engine 334 calculates a separate ratio for each of skill teams 310, 312, and 314 and maintains each of the separate ratios in skill team ratios 337. Therefore, in one illustrative embodiment, skill team ratios 337 include a ratio of segmented work 326 that remains unperformed to the number of members of skill team resources 316, a ratio of segmented work 328 that remains unperformed to the number of members of skill team resources 318, and a ratio of segmented work 330 that remains unperformed to the number of members of skill team resources 320.

Process control engine 334 calculates and maintains skill team thresholds 338 for each of skill teams 310, 312, and 314. Each of skill team thresholds 338 delineates the volume of work one of work queues 332, 333, and 335 before an associated one of skill team resources 316, 318, or 320 from one of skill teams 310, 312, and 314 will be released to perform work held within another of work queues 332, 333, and 335. Skill team thresholds 338 indicate the threshold at which the volume of segmented work 326, 328, and 330 within work queues 332, 333, and 335, respectively, is considered statistically unlikely. Skill team thresholds 338 account for the number of members of skill team resources 316, 318, and 320 prior to reallocating work. Process control engine 334 calculates each of skill team thresholds 338 by determining the historical upper and lower natural process limits for an associated one of the maintained skill team ratios 337. While natural process limits are typically set at some multiple of a standard deviation from the mean, an operator or administrator can programmatically set skill team thresholds 338 so that skill team resources 316, 318, and 320 are more or less likely to be reassigned to tasks outside of their associated work queue 332, 333, or 335. In one illustrative embodiment, skill team thresholds 338 are set at three standard deviations from a historical mean of work within the associated work queue 332, 333, or 335. Skill team thresholds 338 include at least an upper skill team threshold and a lower skill team threshold.

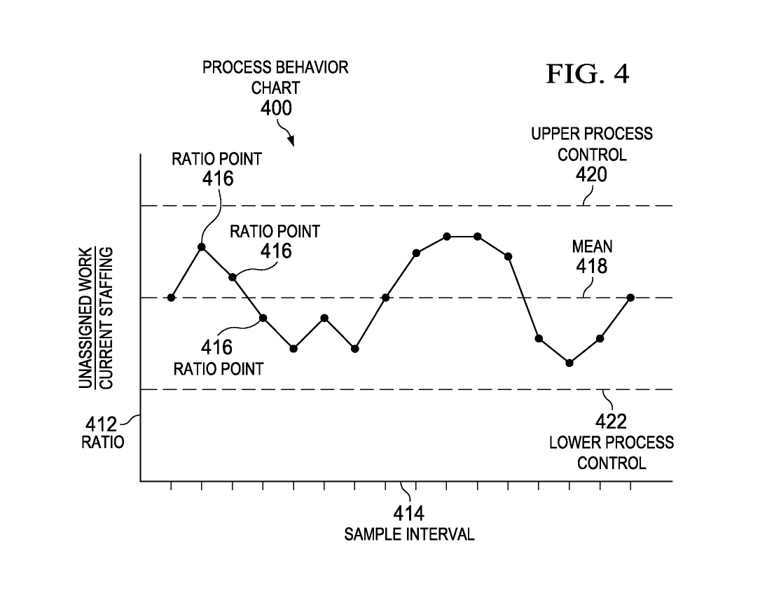

Referring now to FIG. 4, a process behavior control chart is shown according to an illustrative embodiment. Process behavior chart 400 is a graphical indication of the historical ratios between unperformed work contained within a work queue, such as one of work queues 332, 333, and 335 of FIG. 3, to the number of members within an associated skill team resource, such as one of skill team resources 316, 318, and 320 of FIG. 3. A process control engine, such as process control engine 334 of FIG. 3, maintains a separate process behavior chart, such as process behavior chart 400, for each skill team, such as each of skill teams 310, 312, and 314 of FIG. 3.

Process behavior chart 400 plots ratio 412 at each sample interval 414. Ratio 412 is one of skill team ratios 337 of FIG. 3. Sample interval 414 is a time duration between the recording of successive ratio points 416.

Over a given historical duration, a process control engine, such as process control engine 334 of FIG. 3, calculates mean 418 for ratio points 416. Mean 418 is an average of ratio points 416, maintained over a certain number of sample intervals, each of which can be sample interval 414.

Also over the given historical duration, the process control engine calculates upper process control 420 for ratio points 416. Upper process control 420 is an upper natural process limit of ratio points 416, maintained by the process control engine over the certain number of sample intervals. In one illustrative embodiment, the process control engine sets upper process control 420 above mean 418 at three times the standard deviation for ratio points 416. Once the process control engine determines upper process control 420, upper process control 420 becomes a skill team threshold, such as one of skill team thresholds 338 of FIG. 3.

Additionally, over the given historical duration, the process control engine calculates lower process control 422 for ratio points 416. Lower process control 422 is a lower natural process limit of ratio points 416, maintained by the process control engine over the certain number of sample intervals. In one illustrative embodiment, the process control engine sets lower process control 422 below mean 418 at three times the standard deviation for ratio points 416. Once determined, lower process control 422 becomes a skill team threshold, such as one of skill team thresholds 338 of FIG. 3.

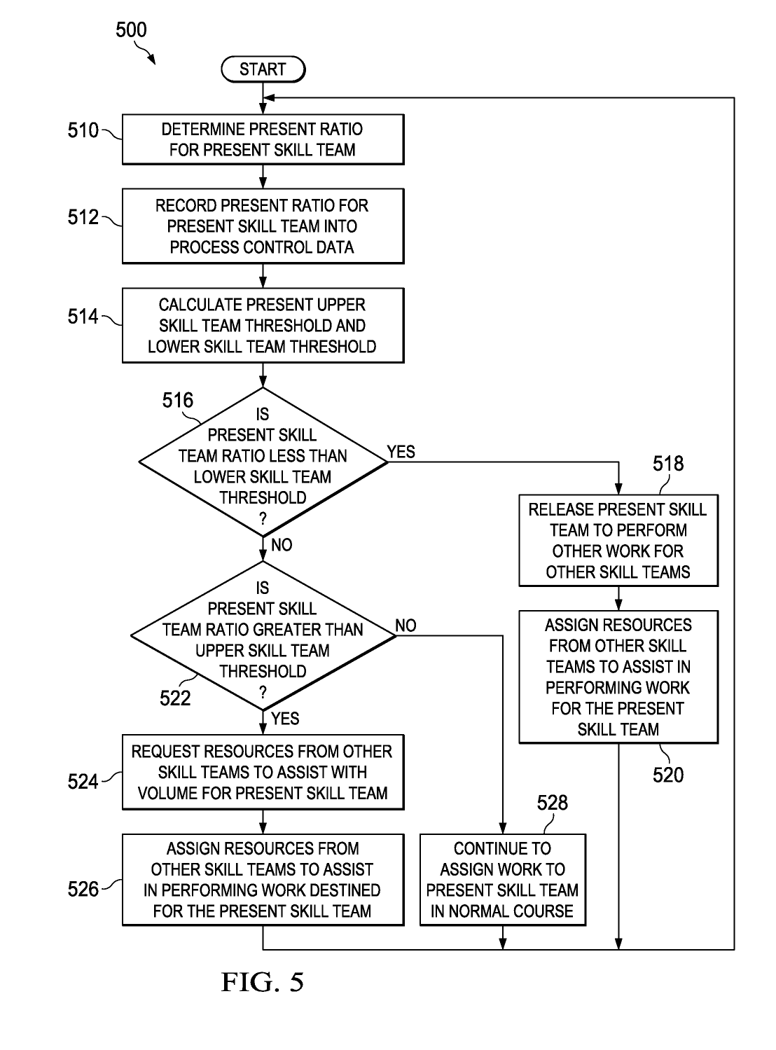

Referring now to FIG. 5, a flowchart for allocating resources within a workload management program is shown according to an illustrative embodiment. Process 500 is a software process, executing on software components, such as process control engine 334 of FIG. 3. It will be understood that, in one exemplary embodiment, each block or combination of blocks shown in FIG. 5 can be implemented by program instructions of program code 218 of FIG. 2, which program instructions can be stored on one or more of computer readable storage devices 220 of FIG. 2 and can be executed by processor unit 204 of FIG. 2.

Process 500 begins when the process control engine determines a present ratio for a present skill team (block 510). The present ratio is the ratio between unperformed work contained within a work queue, such as one of work queues 332, 333, and 335 of FIG. 3, to the number of members within an associated skill team resource, such as one of skill team resources 316, 318, and 320 of FIG. 3. The present ratio can be, for example, ratio 412 of FIG. 4.

At block 512, the process control engine records the present ratio for the present skill team into process control data. The process control data can be stored as a skill team ratio, such as one of skill team ratios 337 of FIG. 3. A historical perspective of the skill team ratio can be visualized as a set of ratio points within a process behavior chart, such as ratio points 416 of process behavior chart 400 of FIG. 4.

At block 514, the process control engine calculates a present upper skill team threshold and a lower skill team threshold. The upper skill team threshold and lower skill team threshold are skill team thresholds, such as skill team thresholds 338 of FIG. 3.

Over a given historical duration defined by an operator, the process control engine can calculate process controls, such as upper process control 420 and lower process control 422 of FIG. 4, for the set of ratio points. Once the process control engine determines the upper process control and the lower process control, the upper process control and the lower process control become skill team thresholds, such as one of skill team thresholds 338 of FIG. 3.

At block 516, the process control engine determines whether the present skill team ratio is less than the lower skill team threshold. Responsive to determining that the present skill team ratio is less than the lower skill team threshold (“yes” at block 516), the process control engine releases the present skill team to perform other work for other skill teams at block 518, as the present skill team is experiencing a statistically unlikely low volume of work allocated to the present skill team. Therefore, the present skill team can take on additional work that would otherwise be assigned to another skill team, so long as the present skill team possesses the necessary expertise to handle the reassigned work.

Responsive to releasing the present skill team to perform other work for other skill teams at block 518, the process control engine assigns resources from other skill teams to assist in performing work for the present skill team (block 520). Process 500 then iterates back to block 510 to determine a next ratio at a next time interval.

Returning now to block 516, responsive to determining that the present skill team ratio is not less than the lower skill team threshold (“no” at block 516), the process control engine determines whether the present skill team ratio is greater than the upper skill team threshold (block 522). Responsive to determining that the present skill team ratio is greater than the upper skill team threshold (“yes” at block 522), the process control engine requests resources from other skill teams to assist with the volume for the present skill team (block 524), as the present skill team is experiencing a statistically unlikely high volume of work allocated to the present skill team. Therefore, additional work that would otherwise be assigned to the present skill team can be reallocated to other skill teams possessing the necessary expertise to handle work reassigned from the present skill team.

Responsive to requesting resources from other skill teams to assist with the volume for the present skill team at block 524, the process control engine assigns resources from other skill teams to assist in performing work destined for the present skill team at step 526. Process 500 then iterates back to step 510 to determine a next ratio at a next time interval.

Returning now to block 522, responsive to determining that the present skill team ratio is not greater than the upper skill team threshold (“no” at block 522), the process control engine continues to assign work to the present skill team in normal course (block 528). Process 500 then iterates back to step 510 to determine a next ratio at a next time interval.

Thus, the illustrative embodiments herein provide a computer implemented method for allocating resources within a workload management program. A first ratio for a first skill team of a plurality of skill teams is identified. If the first ratio for the first skill team exceeds a skill team threshold of the first skill team, resources are allocated from at least one of the plurality of skill teams.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for allocating resources within a workload management program, the method comprising:
a computer identifying a first ratio for a first skill team of a plurality of skill teams;
the computer determining whether the first ratio for the first skill team exceeds a skill team threshold of the first skill team; and
responsive to the computer determining that the first ratio for the first skill team exceeds the skill team threshold of the first skill team, the computer allocating the resources from at least one of the plurality of skill teams other than the first skill team to the first skill team.

2. The computer implemented method of claim 1, wherein the first ratio is a ratio of unperformed work of the first skill team to a number of members of resources for the first skill team.

3. The computer implemented method of claim 1, further comprising:
responsive the computer to identifying the first ratio, the computer recording the first ratio into process control data for the first skill team.

4. The computer implemented method of claim 3, further comprising:
responsive to the computer recording the first ratio into the process control data:
the computer determining a lower skill team threshold for the first skill team; and
the computer determining an upper skill team threshold for the first skill team.

5. The computer implemented method of claim 4, wherein the lower skill team threshold is a lower natural process limit for the process control data, and wherein the upper skill team threshold is an upper natural process limit for the process control data.

6. The computer implemented method of claim 4, wherein the computer determining whether the first ratio exceeds the skill team threshold of the first skill team further comprises the computer determining whether the first ratio is less than the lower skill team threshold for the first skill team; and
wherein the computer allocating the resources from at least one of the plurality of skill teams further comprises responsive to the computer determining that the first skill team ratio is less than the lower skill team threshold, the computer allocating the resources from the first skill team to perform other work for a second skill team of the plurality of skill teams.

7. The computer implemented method of claim 4, wherein the computer determining whether the first ratio exceeds the skill team threshold of the first skill team further comprises the computer determining whether the first ratio is greater than the upper skill team threshold for the first skill team; and
wherein the computer allocating the resources from at least one of the plurality of skill teams further comprises responsive to the computer determining that the first skill team ratio is greater than the upper skill team threshold, the computer requesting resources from a second skill team of the plurality of skill teams to assist with work assigned to the first skill team.

8. A computer program product for allocating resources within a workload management program, the computer program product comprising:
one or more computer-readable, tangible storage devices;
program instructions, stored on at least one of the one or more storage devices, to identify a first ratio for a first skill team of a plurality of skill teams;
program instructions, stored on at least one of the one or more storage devices, to determine whether the first ratio for the first skill team exceeds a skill team threshold of the first skill team; and
program instructions, stored on at least one of the one or more storage devices, and responsive to determining that the first ratio for the first skill team exceeds the skill team threshold of the first skill team, to allocate the resources from at least one of the plurality of skill teams other than the first skill team to the first skill team.

9. The computer program product of claim 8, wherein the first ratio is a ratio of unperformed work of the first skill team to a number of members of resources for the first skill team.

10. The computer program product of claim 8, further comprising:
program instructions, stored on at least one of the one or more storage devices, responsive to identifying the first ratio, to record the first ratio into process control data for the first skill team.

11. The computer program product of claim 10, further comprising:
program instructions, stored on at least one of the one or more storage devices, and responsive to recording the first ratio into the process control data, to determine a lower skill team threshold for the first skill team; and
program instructions, stored on at least one of the one or more storage devices, and responsive to recording the first ratio into the process control data, to determine an upper skill team threshold for the first skill team.

12. The computer program product of claim 11, wherein the lower skill team threshold is a lower natural process limit for the process control data, and wherein the upper skill team threshold is an upper natural process limit for the process control data.

13. The computer program product of claim 11, wherein the program instructions to determine whether the first ratio exceeds the skill team threshold of the first skill team determine whether the first ratio is less than the lower skill team threshold for the first skill team; and
wherein the program instructions to allocate the resources from at least one of the plurality of skill teams allocate the resources from the first skill team to perform other work for a second skill team of the plurality of skill teams, responsive to determining that the first skill team ratio is less than the lower skill team threshold.

14. The computer program product of claim 11, wherein the program instructions to determine whether the first ratio exceeds the skill team threshold of the first skill team determine whether the first ratio is greater than the upper skill team threshold for the first skill team; and
wherein the program instructions to allocate the resources from at least one of the plurality of skill teams request resources from a second skill team of the plurality of skill teams to assist with work assigned to the first skill team, responsive to determining that the first skill team ratio is greater than the upper skill team threshold.

15. A computer program product comprising one or more computer-readable, tangible storage devices and computer-readable program instructions which are stored on the one or more storage devices and when executed by one or more processors, perform the computer implemented method of claim 1.

16. A computer system for allocating resources within a workload management program, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to identify a first ratio for a first skill team of a plurality of skill teams;
program instructions, stored on at least one of the one or more storage devices for execution by at least one of the one or more processors via at least one of the one or more memories, to determine whether the first ratio for the first skill team exceeds a skill team threshold of the first skill team; and
program instructions, stored on at least one of the one or more storage devices for execution by at least one of the one or more processors via at least one of the one or more memories, and responsive to determining that the first ratio for the first skill team exceeds the skill team threshold of the first skill team, to allocate the resources from at least one of the plurality of skill teams other than the first skill team to the first skill team.

17. The computer system of claim 16, wherein the first ratio is a ratio of unperformed work of the first skill team to a number of members of resources for the first skill team.

18. The computer system of claim 16, further comprising:
program instructions, stored on at least one of the one or more storage devices for execution by at least one of the one or more processors via at least one of the one or more memories, to record the first ratio into process control data for the first skill team.

19. The computer system of claim 18, further comprising:
program instructions, stored on at least one of the one or more storage devices for execution by at least one of the one or more processors via at least one of the one or more memories, and responsive to recording the first ratio into the process control data, to determine a lower skill team threshold for the first skill team; and
program instructions, stored on at least one of the one or more storage devices for execution by at least one of the one or more processors via at least one of the one or more memories, and responsive to recording the first ratio into the process control data, to determine an upper skill team threshold for the first skill team.

20. The computer system of claim 19, wherein the lower skill team threshold is a lower natural process limit for the process control data, and wherein the upper skill team threshold is an upper natural process limit for the process control data.

21. The computer system of claim 19, wherein the program instructions to determine whether the first ratio exceeds the skill team threshold of the first skill team determine whether the first ratio is less than the lower skill team threshold for the first skill team; and
wherein the program instructions to allocate the resources from at least one of the plurality of skill teams allocate the resources from the first skill team to perform other work for a second skill team of the plurality of skill teams, responsive to determining that the first skill team ratio is less than the lower skill team threshold.

22. The computer system of claim 19, wherein the program instructions to determine whether the first ratio exceeds the skill team threshold of the first skill team determine whether the first ratio is greater than the upper skill team threshold for the first skill team; and
wherein the program instructions to allocate the resources from at least one of the plurality of skill teams request resources from a second skill team of the plurality of skill teams to assist with work assigned to the first skill team, responsive to determining that the first skill team ratio is greater than the upper skill team threshold.

23. A computer system comprising one or more processors, one or more computer-readable memories, one or more computer-readable, tangible storage devices and program instructions which are stored on the one or more storage devices for execution by the one or more processors via the one or more memories and when executed by the one or more processors perform the computer implemented method of claim 1
